(19) United States
(12) Patent Application Publication
(10) Pub. No.: US 2003/0121385 A1
(43) Pub. Date: Jul. 3, 2003

(54) Wire cutting apparatus

(76) Inventors: Fritz Hermann, Landsberg (DE); Ulrich Birnbaum, Kaufering (DE)

Correspondence Address: SIDLEY AUSTIN BROWN & WOOD LLP, 787 Seventh Avenue, New York, NY, 10019, US

(21) Appl. No.: 10/243,577

(22) Filed: Sep. 13, 2002

(30) Foreign Application Priority Data
Sep. 17, 2001 (DE) 10145707.3

(51) Int. Cl. B26D 1/44; B26F 1/46

(52) U.S. Cl. 83/651.1; 83/652

(57) ABSTRACT

An apparatus for cutting wire (4) to length if formed of a movable chisel (1) and a holding device including a planar contact surface (3) for guiding a wire (4) moving in the feed advance direction (V). For cutting the wire (4) to length the chisel (1) and a bearing guide (6) for guiding the chisel (1) move transverse to the contact surface. In order to prevent compression of the wire cross-section in the cut zone, the bearing guide (6) allows the chisel to move in the feed advance direction (V).

### FIELD OF THE INVENTION

The invention relates to a wire cutting apparatus for cutting wire to length, in particular spring wire, comprised of a holding device that has a contact surface for guiding a wire in a feed advance direction and a chisel having a cutting edge and moveable in a bearing guide towards the contact surface.

### BACKGROUND OF THE INVENTION:

Cutting devices of the type described above are used in cutting wire to length, for example steel wire. It is particularly applicable for cutting to length wire products having a round cross-section while doing so with minimum burr formation and deformation and cutting to a specific length at an angle certain. Possible products are wire rings, wire springs or the like.

Cutting devices that are comprised of a holding device for guiding a forward advancing wire and a chisel that moves against the holding device are well-known from the generally familiar prior art. The chisel with its cutting edge is guided through the bearing guide at an angle, preferably vertically, to a contact surface formed by the holding device. In the cutting process the forward advance is arrested and the chisel moves with its cutting edge against the wire lying on the contact surface and cuts through the wire with a so-called linear cut.

The drawback in this known solution is that, because of the linear cut, material is compressed in the area of the cut surface and this results in the formation of a burr that extends at least partially over the cross-section of the wire and results further in a deformation of the wire cross-section as a consequence of such compression. Both the burr and the deformation limit, at least at one end of the wire, the possible uses of the wire cut to length in this fashion.

In another generally well-known cutting method a chisel is guided through a bearing guide over an elliptical path at a speed that is matched to the forward advance speed.

The advantage of this solution is that the forward movement of the wire does not have to be stopped in order to cut it.

The drawback to this alternative solution is that the control of the bearing guide of the chisel has a negative affect on the cost effectiveness of manufacturing the cutting device.

### SUMMARY OF THE INVENTION

The object of the present invention is to provide a device for cutting wire to length that allows the economical production of wire lengths that are free of burrs, and deformation.

The object is achieved according to the invention in that the bearing guide allows movement of the cutting edge in the feed advance direction.

Compression of the cross-section of the wire is prevented at the time of cutting, in that the cutting edge moves in the feed advance direction, since the cutting edge can clear in the feed advance direction of the wire. Further, a costly control system as is required in the case of a chisel motor driven in the feed advance direction is unnecessary for the bearing guide and the movable chisel. In a preferred embodiment the cutting edge is fixedly arranged on the chisel.

The bearing guide preferably allows a translatory movement of the chisel in the feed advance direction in order to assure a constructively simple bearing guide.

In a further embodiment, the bearing guide allows pivoting of the chisel around an axis of rotation in the feed advance direction.

The axis of rotation is preferably disposed in the end zone spaced from the cutting edge; for example, the axis runs approximately through the body of the chisel transverse to the feed advance direction and at the end of the chisel facing away from the cutting direction.. Consequently, rotation of the cutting edge approximately in the feed advance direction is facilitated.

The axis of rotation is preferably arranged in the region of the chisel spaced from the cutting edge in the feed advance direction. When this is done, the cutting force produces a torque on the chisel, that pivots the chisel about the axis with rotation in the feed advance direction. The cutting edge of the chisel penetrating into the wire induces a traction force in the feed advance direction in virtue of the movement in the stationary wire. The cross-section of the still unseparated wire is narrowed in the region of the cut and separated This minimizes cutting pressure on the wire and avoids deformation of the wire cross-section and formation of burrs. With the translatory design of the bearing guide, force components in the feed advance direction that are generated with the cutting process and which would otherwise result in the formation of burrs, and cause a displacement of the cutting edge and consequently prevent the formation of a burr. When this is done, it is essential that a space is created between a cutting direction of the chisel and the cutting edge, such space acting as a lever with a movement of the chisel in the cutting direction and so results in a pivoting movement of the chisel.

The bearing guide advantageously has a return element and a stop shoulder spaced apart in the feed advance direction, whereby the chisel is biased in the feed advance direction, at least in the area of the cutting edge, by the return element and is positioned in the starting position in contact with the stop shoulder. In this fashion, reliable guiding of the chisel in the feed advance direction is assured. The starting position of the chisel is particularly defined by the stop shoulder. Further, the return element assures on the one hand guidance of the chisel during the separation process and on the other hand in the starting position assures an urging of the chisel against the stop shoulder. In a further embodiment the spring force of the return element is adjustably fashioned.

The chisel in the starting position is preferably vertical to the contact surface in order to assure the most burr-free cut possible. Depending on the desired cut the chisel can, however, be inclined at an angle when in the starting position.

The contact surface advantageously has a guide assembly for guiding the wire in order to prevent lateral displacement of the wire during the cut and trim process.

Preferably the guide assembly exhibits a guide channel or track running in the feed advance direction, and opening to the contact surface, preferably rounded approximately to the radius of the wire, so that this relative contour can keep deformation to a minimum at the time of cutting and assure a structurally simple and thus economical solution.

### BRIEF DESCRIPTION OF THE DRAWING

In the following the invention is more completely explained using an exemplary embodiment, wherein:

FIG. 1 is a side elevation of a cut and trim device according to the invention; and

FIG. 2 represents an enlarged cross section of the holding device shown in FIG. 1.

### DESCRIPTION OF THE PREFERRED EMBODIMENT

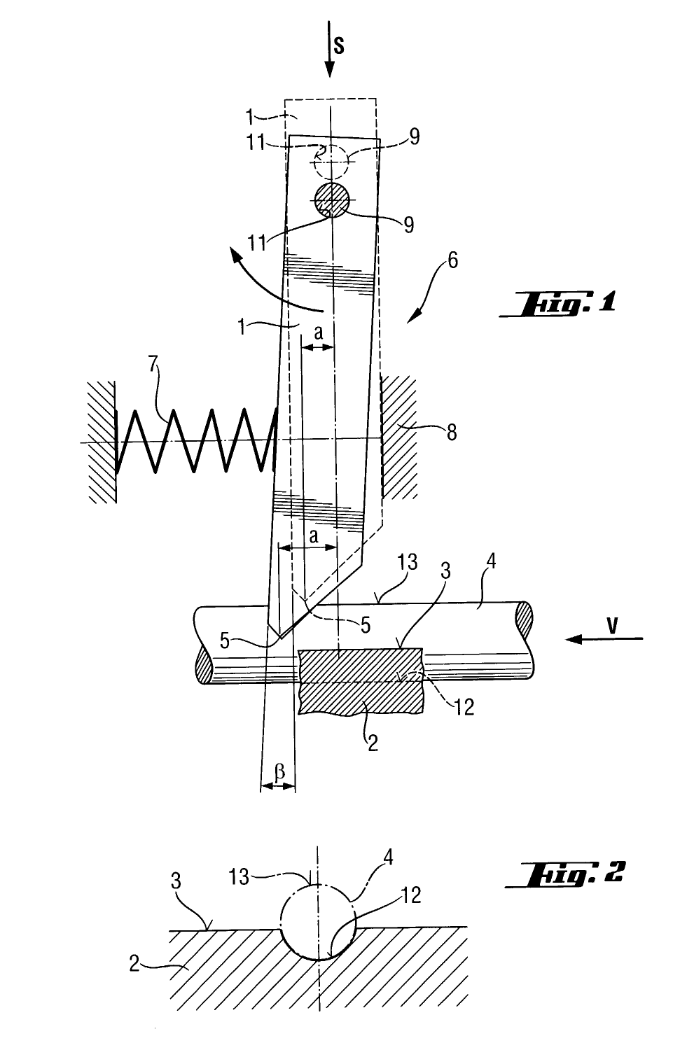

FIGS. 1 and 2 show a cutting apparatus according to the invention comprised of a cutting chisel 1 and a holding device 2, which has a planar contact surface 3 for guiding a wire 4 in a forward feed direction V. The chisel 1 together with its single cutting edge 5 is moveably guided along the contact surface 3 by a bearing guide 6.

The bearing guide 6 is comprised of a return element 7 and a stop shoulder 8. When in the starting position, as shown in FIG. 1, the chisel 1 (shown in broken lines) is in contact with the stop shoulder 8. The return element 7 acting opposite to the forward feed direction V of the wire 4 urges the chisel 1 against the stop shoulder 8. Further the bearing guide 6 includes a fastening bolt 9 vertically displaceable relative to the contact surface 3, the bolt passing through a through hole 11 in the chisel 1. The through hole 11 is preferably arranged on the end of the chisel 1 spaced from the contact surface 3 at distance a running from the cutting edge 5 opposite to the feed advance direction V. If a force acts in the cutting direction S, the gap a running perpendicular to the cutting direction S effects a pivoting of the chisel 1, in particular the cutting edge 5, relative to the wire 4.

The holder device 2 exhibits a guide assembly for lateral guiding of the wire 4 in the feed advance direction V. As can be seen particularly in FIG. 2, the guide assembly exhibits a semi-circular guide track 12 recessed in the contact surface 3 and running in the feed advance direction V.

During the cutting process the wire 4 is moved in the feed advance direction V through the guide track 12 formed in the holder 2. The chisel 1 is situated in the starting position (shown in broken lines in FIG. 1) in which position it lies against the stop shoulder 8. Initially the chisel 1 is moved through the bearing guide 6 to the desired position of the wire 4 in the cutting direction S essentially transverse to the contact surface 3. The stop shoulder 8, the return element 7 and the fastener bolt 9, designated overall as the bearing guide 6, move with it. The cutting process begins when the chisel 1 contacts the outer surface 13 of the wire 4 with its cutting edge 5. With the cutting process the chisel 1 moves initially farther in the cutting direction S and the movement of the wire 4 in the feed advance direction V is arrested. On cutting through the wire 4 the chisel 1 is pivoted in the feed advance direction V against the spring force of the return element 7 around the axis formed by the fastening bolt 9 and distance a, running opposite to the feed advance direction, from the cutting edge 5. Once the wire 4 is cut through, the chisel 1 is returned to the starting position. Preferably the spring force of the return element 7 is adjustable.

What is claimed is:

1. Wire cutting apparatus for cutting wire (4) to length, particularly a spring wire, comprising a device (2) for holding the wire (4), said device (2) is formed of a contact surface (3) for guiding the wire (4) moving in a feed advance direction (V) and an elongated chisel (1) having a cutting edge (5) at one end thereof movable toward said contact surface (3) in a bearing guide (6) allowing movement of said cutting edge (5) in the feed advance direction (V).

2. Wire cutting apparatus, as set forth in claim 1, wherein said bearing guide (6) affords translatory movement of said chisel (1) in the feed advance direction (V).

3. Wire cutting apparatus, as set forth in claim 1, wherein said bearing guide (6) effects pivoting motion of said chisel (1) about an axis of rotation.

4. Wire cutting apparatus, as set forth in claim 3, wherein said axis of rotation is located in an end region of said elongated chisel (1) spaced from said cutting edge (5) at the one end of said chisel (1).

5. Wire cutting apparatus, as set forth in claim 4, wherein said axis of rotation extends through said chisel (1), transversely of the feed advance direction (V) and spaced from said contact surface (4).

6. Wire cutting apparatus, as set forth in claim 1, wherein said bearing guide (6) for said chisel (1) includes a return element (7) and a stop shoulder (8) facing in the feed advance direction (V).

7. Wire cutting apparatus, as set forth in claim 1, wherein said chisel (1) has a first position at the start of the cutting operation extending perpendicular to said contact surface (3).

8. Wire cutting apparatus, as set forth in claim 1, wherein said contact surface (3) has a guide means for guiding the wire (4) extending transversely of the feed advance direction (V).

9. Wire cutting apparatus, as set forth in claim 8, wherein said guide means comprises a guide track (12) recessed in said contact surface and running in the feed advance direction (V).

10. Wire cutting apparatus, as set forth in claim 9, wherein said guide track (12) has a configuration conforming to a portion of the transverse cross-section of said wire (4).

11. Wire cutting apparatus, as set forth in claim 3, wherein said chisel (1) has a dimension extending in the feed advance direction (V) said axis of rotation is approximately one
